(19) United States
(12) Patent Application Publication
(10) Pub. No.: US 2016/0073663 A1
(43) Pub. Date: Mar. 17, 2016

(54) EMULSIFIER COMPOSITION

(71) Applicant: DUPONT NUTRITION BIOSCIENCES APS, Copenhagen K (DK)

(72) Inventors: Flemming Vang Sparsoe, Skanderborg (DK); Anne Kathrine Laursen, Skanderborg (DK)

(21) Appl. No.: 14/888,869

(22) PCT Filed: May 7, 2014
(86) PCT No.: PCT/EP2014/059394

§ 371 Date: Nov. 3, 2015

(30) Foreign Application Priority Data
May 13, 2013 (GB) 1308502.2

(51) Int. Cl. A23L 1/035; A21D 2/16; A23L 1/015

(52) U.S. Cl. CPC A23L 1/035; A23L 1/015; A21D 2/16; A23V 2002/00

(57) ABSTRACT

There is provided an emulsifier composition comprising (a) a diacetyl tartaric acid ester of mono- and diglycerides (DATEM); (b) free acetic acid in an amount of less than 0.4 wt % based on the amount of DATEM; and (c) a salt or base, wherein the salt or base is capable of donating a metal ion to one or more carboxylic acids present in the DATEM to form a salt of the carboxylic acid present in the DATEM, wherein the salt or base is present in an amount to provide a degree of neutralisation of at least 0.25 mol %.

The present invention relates to a stabilised, deodorised emulsifier composition, a process for preparing the same and use of materials for stabilising deodorised emulsifier compositions.

Diacetyl tartaric acid ester of mono- and diglycerides (DATEM) is a powerful emulsifier which is used extensively in bakery applications. The use in bakery is a relative mature market with significant but stable levels of DATEM usage. DATEM is assumed to have a great potential beyond bakery if a key disadvantage could be overcome. This disadvantage is that DATEM has a characteristic smell of acetic acid.

The present invention addresses the problems of providing a DATEM which can be used in applications which are sensitive to the characteristic smell of acetic acid. In particular, the invention relates to providing an odorless DATEM with a lengthy storage stability of the order of months, and ideally 6 months or more or 12 months or more.

It is known from the prior art that acetic acid odour of DATEM can be removed by a water vapor deodorization procedure without affecting the functionality of DATEM. The deodorization can be done by a batch wise procedure or by a continuous procedure. By these procedures a product with less than 0.4%, and ideally less than 0.1%, free acetic acid can be produced. However it is known that these deodorized products gradually release free acetic acid over time and that the characteristic acetic acid odour returns. The present invention addresses the problem of stabilizing deodorized DATEM products such that the characteristic acetic acid odour does not rapidly return.

The present invention alleviates the problems of the prior art.

In one aspect the present invention provides an emulsifier composition comprising

(a) a diacetyl tartaric acid ester of mono- and diglycerides (DATEM);
(b) free acetic acid in an amount of less than 0.4 wt % based on the amount of DATEM; and
(c) a salt or base, wherein the salt or base is capable of donating a metal ion to one or more carboxylic acids present in the DATEM to form a salt of the carboxylic acid present in the DATEM, wherein the salt or base is present in an amount to provide a degree of neutralisation of at least 0.25 mol %.

In one aspect the present invention provides a process for the preparation of emulsifier composition comprising
(a) a diacetyl tartaric acid ester of mono- and diglycerides (DATEM);
(b) free acetic acid in an amount of less than 0.4 wt % based on the amount of DATEM; and
(c) a salt or base, wherein the salt or base is capable of donating a metal ion to one or more carboxylic acids present in the DATEM to form a salt of the carboxylic acid present in the DATEM, wherein the salt or base is present in an amount to provide a degree of neutralisation of at least 0.25 mol %,
   the process comprising
   i) providing a diacetyl tartaric acid ester of mono- and diglycerides (DATEM);
   ii) optionally deodorising the DATEM such that the DATEM contains free acetic acid in an amount of less than 0.4 wt % based on the amount of DATEM; and
   iii) prior to or subsequent to step ii), combining the DATEM with a salt or base, wherein the salt or base is capable of donating a metal ion to one or more carboxylic acids present in the DATEM to form a salt of the carboxylic acid present in the DATEM wherein the salt or base is present in an amount to provide a degree of neutralisation of at least 0.25 mol %.

In one aspect the present invention provides use of a salt or base for stabilising a diacetyl tartaric acid ester of mono- and diglycerides (DATEM), wherein the salt or base is capable of donating a metal ion to one or more carboxylic acids present in the DATEM to form a salt of the carboxylic acid present in the DATEM.

In one aspect the present invention provides use of a salt or base for reducing or inhibiting the release of acetic acid from a diacetyl tartaric acid ester of mono- and diglycerides (DATEM), wherein the salt or base is capable of donating a metal ion to one or more carboxylic acids present in the DATEM to form a salt of the carboxylic acid present in the DATEM.

In one aspect the present invention provides an emulsifier composition as substantially described with reference to the Examples.

In one aspect the present invention provides a process as substantially described with reference to the Examples.

In one aspect the present invention provides a use as substantially described with reference to the Examples.

We have surprisingly found that a deodorised DATEM composition can be stabilised with respect to the further formation of acetic acid by the inclusion in the DATEM composition of a salt or base which is capable of donating a metal ion to one or more carboxylic acids present in the DATEM. The metal ion donated by the salt or base forms a salt of the carboxylic acid present in the DATEM.

The present invention provides a means for stabilising DATEM compositions after deodorisation. This allows for the long term storage of DATEM compositions without the development or return of an unacceptable acetic acid odour. By this means, the DATEM compositions may be used in application areas which were previously not available because of acetic acid odour.

For ease of reference, these and further aspects of the present invention are now discussed under appropriate section headings. However, the teachings under each section are not necessarily limited to each particular section.

### DETAILED DESCRIPTION

As discussed herein, the present invention provides an emulsifier composition comprising (a) a diacetyl tartaric acid ester of mono- and diglycerides (DATEM); (b) free acetic acid in an amount of less than 0.4 wt % based on the amount of DATEM; and (c) a salt or base, wherein the salt or base is capable of donating a metal ion to one or more carboxylic acids present in the DATEM to form a salt of the carboxylic acid present in the DATEM wherein the salt or base is present in an amount to provide a degree of neutralisation of at least 0.25 mol %.

### DATEM

As discussed above, diacetyl tartaric acid ester of mono- and diglycerides (DATEM) are well known emulsifiers. These emulsifiers are generally regarded as safe and can be prepared by several different methods.

The DATEM of the present invention may be prepared by methods known in the art such as those disclosed in the following documents. U.S. Pat. No. 2,236,516 (Frank J. Cahn et al) is an early patent specification disclosing products obtained by reacting diacetyl tartaric acid with glyceryl monostearate. U.S. Pat. No. 2,689,797 (Morris H. Joffe) discloses improvements in bread obtained by the incorporation of Diacetyl tartaric esters of unsaturated and partially saturated mono and/or partial glycerides. U.S. Pat. No. 2,938,027 (Martell M. Gladstone) discloses the reaction between mixtures of acetylated anhydrides of food acids such as e.g. tartaric acid containing 4 to about 95% of diacetylated tartaric acid and e.g. free acetic anhydride with partial glycerides of fatty acids to obtain improved products. U.S. Pat. No. 3,443,969 (Nobuo Nakejima et al) discloses diacetyl tartaric esters of purified (molecular distilled) monoglycerides of vegetable oils. GB-A-1 220 488 (Aktieselskabet Grindstedvaerket) discloses the preparation of an emulsifier obtained by reacting e.g. distilled glycerol monostearate with diacetyl tartaric anhydride in certain molar ratios followed by prolonged heating to 135-190° C. as to obtain by polymerization a satisfactory oil-in-water emulsifier of higher molecular weight, which apparently contains polymeric esters due to splitting off acetic acid and water. GB-A-1 344 518 (Dynamit Nobel A. G.) discloses solid acetyl tartaric esters obtained by reacting at least partially acetylated tartaric acid with partial glycerides containing 55-65% monoglyceride and an iodine value below 5 which contain per mole of partial glyceride 0.91-1.8 mole tartaric acid residues and 1.8-3.4 mole acetic acid residues. These esters are free flowing powders whereas the traditional esters have a waxy or honey-like consistency. EP-1 016 647 (QUEST INTERNATIONAL B.V.) describes a two-step procedure: Purified tartaric acid anhydride is produced in step one followed by reaction with distilled monoglyceride and sodium stearate in a second step. A product is provided having a degree of neutralisation of 0.21%. US-2012/0058232 (Gaofeng Liu, Shuming Yu) describes a method for preparing diacetyl tartaric acid esters of mono- and diglyceride having a degree of neutralisation of 0.09%. by an esterification reaction in the presence of concentrated phosphoric acid.

The diacetylated tartaric acid esters in the present invention can be prepared from monoglyceride and monodiglycerides containing 40%-99% monoglyceride based on commercial available fats and oils containing saturated and/or unsaturated fatty acids of variable lengths (C8-C22). The quantity of tartaric acid is typically between 10 and 35%. In some aspects, the DATEM may contain triglyceride as an extender.

Suitable oils and fats raw materials for the monoglyceride, mono-diglyceride and triglyceride extender are selected from but not limited to non-refined, refined, hydrogenated, partially hydrogenated or fractionated oils and fats of animal or vegetable origin such as but not limited to almond oil, babassu oil, butter oil, chicken fat, castor oil, cocoa butter, coconut oil, cotton seed oil, evening primrose oil, fish oil, hazelnut oil, illipe fat, kokorm, lard, linseed oil, maize oil, mango, menhaden oil, olive oil, palm kernel oil, palm oil, peanut oil, rapeseed oil (high and low erucic), rice bran oil, safflower oil, high oleic safflower oil, seal oil, sesame oil, shea fat, soybean oil, high oleic soybean oil, sunflower oil, high oleic sunflower oil, tall oil, tallow, tung oil, algae oil, single cell algae oil and a mixture of any of these oils and/or fats.

DATEM can be described by the chemical structures DATEM I through IV, which are the main chemical components of DATEM. In addition DATEM compositions may contain unreacted mono- and mono-diglyceride, and triglyceride.

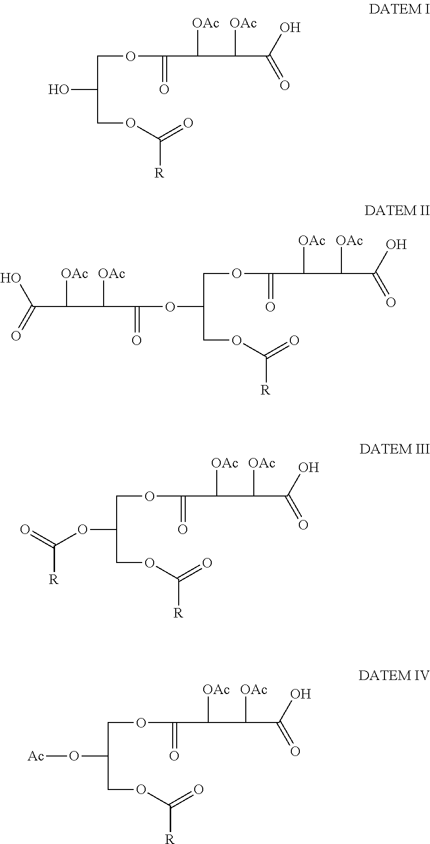

wherein R is a fatty acid chain. Typical fatty acid chains are C4 to C28 chains which are either saturated or contain one or more degrees of unsaturation. Typical fatty acids are described herein. Each of the molecules DATEM I-IV will have positional isomers wherein the position of each substituent or free hydroxyl group on the glycerol back bone may vary.

As will be appreciated by one skilled in the art, each of the DATEM I-IV molecules contains at least one carboxylic acid which is available for neutralisation with a salt or a base as defined below.

### Deodorised

As discussed herein, the composition of the present invention includes free acetic acid in an amount of less than 0.4 wt % based on the amount of DATEM. Such a low amount of acetic acid is typically provided by synthesising the DATEM and then subjecting the DATEM to a deodorisation process. However, one skilled in the art will appreciate that using suitable methods it may be possible to synthesise a DATEM containing free acetic acid in an amount of less than 0.4 wt %. Thus in the process of the present invention, in one aspect there is provided a diacetyl tartaric acid ester of mono- and diglycerides (DATEM); which is then optionally deodorised such that the DATEM contains free acetic acid in an amount of less than 0.4 wt % based on the amount of DATEM. In one aspect, the deodorisation is not performed. In one other aspect the DATEM is deodorised such that it contains the required amount of free acetic acid, namely free acetic acid in an amount of less than 0.4 wt % based on the amount of DATEM.

In one aspect, the free acetic acid in the emulsifier composition is present in an amount of less than 0.3 wt % based on the amount of DATEM, such as in an amount of less than 0.2 wt %, such as in an amount of less than 0.1 wt %, such as in an amount of less than 0.05 wt %, such as in an amount of less than 0.04 wt %, such as in an amount of less than 0.03 wt %, such as in an amount of less than 0.03 wt %, such as in an amount of less than 0.01 wt % based on the amount of DATEM.

A deodorisation process is understood to be a process by which unwanted odour or volatile components such as acetic acid can be removed from a product. The process can typically be performed by supplying water vapour typically between 0.01 to 2 wt % based on the product into a product under vacuum typically held at an absolute pressure of 0.1-10 kPa. The product is heated to a temperature suitable for evaporation of the unwanted components. For acetic acid this temperature is typically between 100 and 180° C. The process can be performed in both a batch and a continuous process.

### Stabilising Agent

As will be understood by one skilled in the art, in the present composition there is included a salt or base which stabilises the composition. In one aspect in the present composition there is included a salt which stabilises the composition. In one aspect in the present composition there is included a base which stabilises the composition. The salt or base may be regarded as a stabilising agent. As discussed herein, the salt or base is capable of donating a metal ion to one or more carboxylic acids present in the DATEM to form a salt of the carboxylic acid present in the DATEM, wherein the salt or base is present in an amount to provide a degree of neutralisation of at least 0.25 mol %.

As discussed herein, in one aspect the present invention provides use of a salt or base for reducing or inhibiting the release of acetic acid from a diacetyl tartaric acid ester of mono- and diglycerides (DATEM), wherein the salt or base is capable of donating a metal ion to one or more carboxylic acids present in the DATEM to form a salt of the carboxylic acid present in the DATEM. In this aspect, the salt or base is preferably present in an amount to provide a degree of neutralisation of at least 0.25 mol %.

The salt or base may be selected by one skilled in the art in view of their knowledge of the carboxylic acids present in the DATEM. We have surprisingly found that by neutralising carboxylic acids present in the DATEM, the formation of free acetic acid is inhibited. Without being bound by theory, it is believed that the presence of the carboxylic acid catalyses the release of acetic acid and that by neutralising or partially neutralising the carboxylic acids this release is diminished.

In one preferred aspect, the salt or base (c) is capable of donating a metal ion to a carboxylic acid present in the DATEM product selected from DATEM I, DATEM II, DATEM III, DATEM IV, positional isomers thereof and mixtures thereof. In one preferred aspect, the salt or base (c) is capable of donating a metal ion to a carboxylic acid present in the DATEM product selected from DATEM I, DATEM II, DATEM III, DATEM IV, and mixtures thereof.

Preferably the base (c) is a base of a metal selected from Group 1 of the periodic table, Group 2 of the periodic table and Al. Preferred metals are selected from lithium, sodium, potassium, magnesium, calcium and aluminium. Preferred metals are selected from sodium, potassium, magnesium, and calcium. Preferred metals are selected from magnesium, and calcium. Preferably the base (c) is a base of calcium. Preferably the base (c) is a base of magnesium.

The counter ion or ions of the base is preferably hydroxide. Preferred bases are sodium hydroxide, potassium hydroxide, magnesium hydroxide, calcium hydroxide and aluminium hydroxide. Most preferably the base (c) is magnesium hydroxide.

As will be understood by one skilled in the art salts are typically formed by reaction between a base and an acid, or between a metal salt of an acid with a higher pKa value than the acid which is being neutralized. In one aspect of the present invention the salt (c) is a salt formed by reaction of a base with a carboxylic acid. In one aspect of the present invention the salt (c) is a salt formed by the reaction of a metal salt and an acid with a lower pKa value present in the DATEM. When the salt (c) is a salt of a metal and an acid, the salt (c) is a metal salt capable of donating a metal ion to one or more carboxylic acids present in the DATEM to form a salt of the carboxylic acid present in the DATEM.

Preferably the salt (c) is a salt of a metal selected from Group 1 of the periodic table, Group 2 of the periodic table and Al. Preferred metals are selected from lithium, sodium, potassium, magnesium, calcium and aluminium. Most preferably the salt (c) is a salt of calcium.

With regard to the acid which may form the salt (c), this will typically be an organic acid. Preferably the salt (c) is a salt of a monocarboxylic acid. In a further preferred aspect, the salt (c) is a salt of an acid selected from formic acid, acetic acid, propionic acid and lactic acid. In a highly preferred aspect, the salt (c) is a salt of acetic acid.

Preferably the salt (c) is a salt of (i) a metal selected from lithium, sodium, potassium, magnesium, calcium and aluminium and (ii) an acid selected from formic acid, acetic acid, propionic acid and lactic acid. Preferably the salt (c) is a salt of (i) a metal selected from sodium, potassium, magnesium and calcium and (ii) an acid selected from formic acid, acetic acid, propionic acid and lactic acid. Preferably the salt (c) is a salt of (i) a metal selected from lithium, sodium, potassium, magnesium, calcium and aluminium and (ii) an acid selected from acetic acid and lactic acid.

Particularly preferred combinations of metal and acid provide the following salts—calcium acetate, sodium acetate, magnesium acetate, magnesium lactate, potassium acetate and aluminium acetate and mixtures thereof. Further preferred combinations of metal and acid provide the following salts—calcium acetate, sodium acetate, potassium acetate and aluminium acetate and mixtures thereof. In a highly preferred aspect, the salt (c) is at least calcium acetate or consists of calcium acetate.

Most preferably the base or salt (c) is selected from magnesium hydroxide, calcium acetate, sodium acetate, magnesium acetate, magnesium lactate, calcium lactate, potassium acetate and aluminium acetate and mixtures thereof. Most preferably the base or salt (c) is selected from magnesium hydroxide, calcium acetate, sodium acetate, magnesium acetate, magnesium lactate, potassium acetate and aluminium acetate and mixtures thereof.

In a preferred embodiment the part of the salt or base not being the metal ion i.e. the counter ion is capable of forming an acid or neutral molecule, such as but not limited to a carboxylic acid, such as acetic acid, water or CO₂, which can be subsequently removed, for example liberated or broken down, during the deodorisation process. The salt may be present in any suitable amount to provide a stabilising effect.

The quantity of stabilizing agent present is calculated using degree of neutralization on a molar basis of the tartaric acid used in the preparation of the DATEM. The degree of neutralization can be defined as the molar percent of tartaric acid used to produce the DATEM, which is neutralized with the stabilizer. The degree of neutralization can be calculated according to the following formula:

$$x = \frac{{q}_{Stabilizer} * {n}_{Stabilizer}}{{n}_{Tartaricacid}} \cdot 100 \% = \frac{( \frac{{q}_{Stabilizer} \cdot {m}_{Stabilizer}}{M {W}_{Stabilizer}} )}{( \frac{{m}_{Tartaricacid}}{{Mw}_{Tartaricacid}} )} \cdot 100 \%$$

Where x is the degree of neutralisation i.e. the molar percent of tartaric acid neutralized with the stabilizer, q_{Stabilizer} is the valency of the metal cation of the stabilizer, n_{Stabilizer} is the mole stabilizer added to the DATEM, n_{Tartaricacid} is the mole tartaric acid used in the preparation of the DATEM, m_{Stabilizer} is the amount of stabilizer used in the neutralization of the DATEM in gram and MW_{Stabilizer} is the molar weight of the stabilizer in gram/mole, m_{Tartaric acid} is the amount of tartaric acid used in the preparation of the DATEM in gram and MW_{Tartaric acid} is the molar weight of tartaric acid in gram/mole.

As discussed herein the salt or base is present in an amount to provide a degree of neutralisation of at least 0.25 mol %. In one preferred aspect the degree of neutralization may be from 0.25 to 100%, preferably from 0.25 to 90%, preferably from 0.25 to 80%, preferably from 0.25 to 70%, preferably from 0.25 to 60%, preferably from 0.25 to 50%, preferably from 0.25 to 40%, preferably from 0.25 to 33%, preferably from 0.25 to 32.2%, preferably from 0.25 to 30%, preferably from 0.25 to 20%, preferably from 0.25 to 17%, preferably from 0.25 to 10%, preferably from 0.25 to 8%, preferably from 0.25 to 7%, preferably from 0.25 to 6.1%, preferably from 0.25 to 5%, preferably from 0.25 to 4%, preferably from 0.25 to 2%.

In a further preferred aspect the degree of neutralization may be from 0.5 to 100%, preferably from 0.5 to 90%, preferably from 0.5 to 80%, preferably from 0.5 to 70%, preferably from 0.5 to 60%, preferably from 0.5 to 50%, preferably from 0.5 to 40%, preferably from 0.5 to 33%, preferably from 0.5 to 32.2%, preferably from 0.5 to 30%, preferably from 0.5 to 20%, preferably from 0.5 to 17%, preferably from 0.5 to 10%, preferably from 0.5 to 8%, preferably from 0.5 to 7%, preferably from 0.5 to 6.1%, preferably from 0.5 to 5%, preferably from 0.5 to 4%, preferably from 0.5 to 2%.

In a further preferred aspect the degree of neutralization may be from 1 to 100%, preferably from 1 to 90%, preferably from 1 to 80%, preferably from 1 to 70%, preferably from 1 to 60%, preferably from 1 to 50%, preferably from 1 to 40%, preferably from 1 to 33%, preferably from 1 to 32.2%, preferably from 1 to 30%, preferably from 1 to 20%, preferably from 1 to 17%, preferably from 1 to 10%, preferably from 1 to 9%, preferably from 1 to 8%, preferably from 1 to 7%, preferably from 1 to 6.1%, preferably from 1 to 6%, preferably from 1 to 5%, preferably from 1 to 4%, preferably from 1 to 2%.

In a further preferred aspect the degree of neutralization may be from 2 to 100%, preferably from 2 to 90%, preferably from 2 to 80%, preferably from 2 to 70%, preferably from 2 to 60%, preferably from 2 to 50%, preferably from 2 to 40%, preferably from 2 to 33%, preferably from 2 to 32.2%, preferably from 2 to 30%, preferably from 2 to 20%, preferably from 2 to 17%, preferably from 2 to 10%, preferably from 2 to 9%, preferably from 2 to 8%, preferably from 2 to 7%, preferably from 2 to 6.1%, preferably from 2 to 6%, preferably from 2 to 5%, preferably from 2 to 4%.

In a further preferred aspect the degree of neutralization may be from 3 to 100%, preferably from 3 to 90%, preferably from 3 to 80%, preferably from 3 to 70%, preferably from 3 to 60%, preferably from 3 to 50%, preferably from 3 to 40%, preferably from 3 to 33%, preferably from 3 to 32.2%, preferably from 3 to 30%, preferably from 3 to 20%, preferably from 3 to 17%, preferably from 3 to 10%, preferably from 3 to 9%, preferably from 3 to 8%, preferably from 3 to 7%, preferably from 3 to 6.1%, preferably from 3 to 6%, preferably from 3 to 5%, preferably from 3 to 4%.

In one highly preferred embodiment, the degree of neutralization is approximately 3.9%.

In one aspect, the salt or base (c) is present in an amount of at least 0.1 wt % based on the amount of DATEM. In one aspect, the salt or base (c) is present in an amount of from 0.1 to 4.0 wt % based on the amount of DATEM. In one aspect, the salt or base (c) is present in an amount of from 0.1 to 2.0 wt % based on the amount of DATEM. In one aspect, the salt or base (c) is present in an amount of from 0.1 to 1.0 wt % based on the amount of DATEM. In one aspect the salt or base (c) is present in an amount of at least 0.2 wt % based on the amount of DATEM. In one aspect, the salt or base (c) is present in an amount of from 0.2 to 4.0 wt % based on the amount of DATEM. In one aspect, the salt or base (c) is present in an amount of from 0.2 to 2.0 wt % based on the amount of DATEM. In one aspect, the salt or base (c) is present in an amount of from 0.2 to 1.0 wt % based on the amount of DATEM. In one aspect the salt or base (c) is present in an amount of at least 0.3 wt % based on the amount of DATEM. In one aspect, the salt or base (c) is present in an amount of from 0.3 to 4.0 wt % based on the amount of DATEM. In one aspect, the salt or base (c) is present in an amount of from 0.3 to 2.0 wt % based on the amount of DATEM. In one aspect, the salt or base (c) is present in an amount of from 0.3 to 1.0 wt % based on the amount of DATEM.

In one aspect, the salt (c) is present in an amount of at least 0.1 wt % based on the amount of DATEM. In one aspect, the salt (c) is present in an amount of from 0.1 to 4.0 wt % based on the amount of DATEM. In one aspect, the salt (c) is present in an amount of from 0.1 to 2.0 wt % based on the amount of DATEM. In one aspect, the salt (c) is present in an amount of from 0.1 to 1.0 wt % based on the amount of DATEM. In one aspect the salt (c) is present in an amount of at least 0.2 wt % based on the amount of DATEM. In one aspect, the salt (c) is present in an amount of from 0.2 to 4.0 wt % based on the amount of DATEM. In one aspect, the salt (c) is present in an amount of from 0.2 to 2.0 wt % based on the amount of DATEM. In one aspect, the salt (c) is present in an amount of from 0.2 to 1.0 wt % based on the amount of DATEM. In one aspect the salt (c) is present in an amount of at least 0.3 wt % based on the amount of DATEM. In one aspect, the salt (c) is present in an amount of from 0.3 to 4.0 wt % based on the amount of DATEM. In one aspect, the salt (c) is present in an amount of from 0.3 to 2.0 wt % based on the amount of DATEM. In one aspect, the salt (c) is present in an amount of from 0.3 to 1.0 wt % based on the amount of DATEM.

In one aspect, the base (c) is present in an amount of at least 0.1 wt % based on the amount of DATEM. In one aspect, the base (c) is present in an amount of from 0.1 to 4.0 wt % based on the amount of DATEM. In one aspect, the base (c) is present in an amount of from 0.1 to 2.0 wt % based on the amount of DATEM. In one aspect, the base (c) is present in an amount of from 0.1 to 1.0 wt % based on the amount of DATEM. In one aspect the base (c) is present in an amount of at least 0.2 wt % based on the amount of DATEM. In one aspect, the base (c) is present in an amount of from 0.2 to 4.0 wt % based on the amount of DATEM. In one aspect, the base (c) is present in an amount of from 0.2 to 2.0 wt % based on the amount of DATEM. In one aspect, the base (c) is present in an amount of from 0.2 to 1.0 wt % based on the amount of DATEM. In one aspect the base (c) is present in an amount of at least 0.3 wt % based on the amount of DATEM. In one aspect, the base (c) is present in an amount of from 0.3 to 4.0 wt % based on the amount of DATEM. In one aspect, the base (c) is present in an amount of from 0.3 to 2.0 wt % based on the amount of DATEM. In one aspect, the base (c) is present in an amount of from 0.3 to 1.0 wt % based on the amount of DATEM.

When the salt is a calcium salt, the calcium salt may be present in an amount to provide calcium in an amount of at least 0.0115 wt % based on the amount of DATEM, such as in an amount to provide calcium in an amount of from 0.00115 to 4 wt % based on the amount of DATEM, such as in an amount to provide calcium in an amount of from 0.0115 to 4 wt % based on the amount of DATEM, such as in an amount to provide calcium in an amount from 0.08 to 1.22 wt % based on the amount of DATEM, such as in an amount to provide calcium in an amount from 0.12 to 0.24 wt % based on the amount of DATEM and preferably in an amount of 0.16 wt % based on the amount of DATEM.

When the salt is a sodium salt, the sodium salt may be present in an amount to provide sodium in an amount of at least 0.0132 wt % based on the amount of DATEM, such as in an amount to provide sodium in an amount of from 0.0132 to 4.6 wt % based on the amount of DATEM, such as in an amount to provide sodium in an amount from 0.09 to 1.4 wt % based on the amount of DATEM, such as in an amount to provide sodium in an amount from 0.14 to 0.28 wt % based on the amount of DATEM and preferably in an amount of 0.18 wt % based on the amount of DATEM.

When the salt is a potassium salt, the potassium salt may be present in an amount to provide potassium in an amount of at least 0.0224 wt % based on the amount of DATEM, such as in an amount to provide potassium in an amount of from 0.0224 to 7.8 wt % based on the amount of DATEM, such as in an amount to provide potassium in an amount from 0.16 to 2.38 wt % based on the amount of DATEM, such as in an amount to provide potassium in an amount from 0.23 to 0.47 wt % based on the amount of DATEM and preferably in an amount of 0.31 wt % based on the amount of DATEM.

When the salt is a magnesium salt, the magnesium salt may be present in an amount to provide magnesium in an amount of at least 0.007 wt % based on the amount of DATEM, such as in an amount to provide magnesium in an amount of from 0.007 to 2.4 wt % based on the amount of DATEM, such as in an amount to provide magnesium in an amount from 0.05 to 0.74 wt % based on the amount of DATEM, such as in an amount to provide magnesium in an amount from 0.07 to 0.15 wt % based on the amount of DATEM and preferably in an amount of 0.1 wt % based on the amount of DATEM.

It will be understood by one skilled in the art that the stabilizing agent may be incorporated into the emulsifier composition at any stage during its production. For example, the stabilizing agent may be incorporated into the emulsifier composition:
a) before esterification to form the DATEM
b) after esterification and before deodorization
c) after deodorization
d) a combination of one or more of a), b) and c)

In one preferred aspect, the stabilising agent is added to the acetic acid, tartaric acid and monoglycerides prior to their esterification to form the DATEM

The stabilisation provided by the present invention may be effective across a range of temperatures. In one aspect the stabilisation provided by the invention is effective when the emulsifier composition is stored at a temperature of 10° C. or greater, such as a temperature of 15° C. or greater, such as a temperature of 20° C. or greater, such as a temperature of 25° C. or greater, such as a temperature of 30° C. or greater, such as a temperature of 10 to 100° C., such as a temperature of 15 to 100° C., such as a temperature of 20 to 100° C., such as a temperature of 25 to 100° C., such as a temperature of 30 to 100° C., such as a temperature of 10 to 90° C., such as a temperature of 15 to 90° C., such as a temperature of 20 to 90° C., such as a temperature of 25 to 90° C., such as a temperature of 30 to 90° C., such as a temperature of 10 to 80° C., such as a temperature of 15 to 80° C., such as a temperature of 20 to 80° C., such as a temperature of 25 to 80° C., such as a temperature of 30 to 80° C., such as a temperature of 10 to 70° C., such as a temperature of 15 to 70° C., such as a temperature of 20 to 70° C., such as a temperature of 25 to 70° C., such as a temperature of 30 to 70° C., such as a temperature of 10 to 60° C., such as a temperature of 15 to 60° C., such as a temperature of 20 to 60° C., such as a temperature of 25 to 60° C., such as a temperature of 30 to 60° C., such as a temperature of 10 to 50° C., such as a temperature of 15 to 50° C., such as a temperature of 20 to 50° C., such as a temperature of 25 to 50° C., such as a temperature of 30 to 50° C.

It will be understood by one skilled in the art that many emulsifier compositions are stored at low temperatures, such as even as low as refrigeration temperatures. This is typically to delay degradation of the product. By use of the present invention it is possible to store emulsifier compositions at higher temperatures, such as ambient temperatures. This offers a significant advantage both in the distribution chain and in the cost of storage for the end user of the emulsifier.

### Additional Processes

After the DATEM has been prepared a person skilled in the art will be able to select a process by which a DATEM product can be finalised and packed in a way that fulfils the requirements of a given customer.

DATEM products which are liquid or paste at room temperature may be cooled and packed in suitable containers.

A DATEM product with a melting point above 40° C. may be spray cooled, flaked, or grinded or by other means converted into a powder.

### Additional Components

The composition of the present invention may contain one or more further components.

A DATEM powder can subsequently be added anti-caking agents such as, calcium carbonate, calcium silicate, tricalcium phosphate etc. in order to prevent lumping of the powder.

### Composition

It is to be appreciated that the product obtainable and/or obtained by the process of the present invention is encompassed by the present invention. Accordingly in further aspects the present invention provides
a composition obtainable by the process of the present invention
a composition obtained by the process of the present invention

The composition of the present invention may be used in the preparation of any number of products, in particular food products such as bakery foodstuffs and whipped foodstuffs. Thus in further aspects, the present invention provides
a bakery product comprising or prepared from a composition of the present invention.
a whipped foodstuff comprising or prepared from a composition of the present invention.

The invention will now be described, by way of example only, with reference to the following Examples.

### Examples

### DATEMs

The following samples were prepared

| Composition | | | Physical |
|---|---|---|---|
| # | Stabilizer | % neutralized | appearance |
| 1 | Ca(OAc)₂ | 0.18 | Flakes |
| 2 | NaOAc | 0.18 | Flakes |
| 3 | Mg(OAc)₂•4H₂O | 0.18 | Flakes |
| 4 | KOAc | 0.18 | Flakes |
| 5 | Ca(OAc)₂ | 4 | Flakes |
| 6 | NaOAc | 4 | Flakes |
| 7 | KOAc | 4 | Flakes |
| 8 | Mg(OAc)₂•4H₂O | 4 | Flakes |
| 9 | Mg(OAc)₂•4H₂O | 4 | Liquid |
| 10 | Ca(OAc)₂ | 4 | Liquid |
| 11 | Ca(OAc)₂ | 4 | Liquid |
| 12 | Ca(OAc)₂ | 4 | Liquid |
| 13 | Magnesium lactate | 4 | Liquid |
| 14 | NaOAc | 4 | Liquid |
| 15 | KOAc | 4 | Liquid |
| 16 | Ca(OAc)₂ | 4 | Liquid |
| 17 | Ca(OAc)₂ | 4 | Liquid |
| 18 | Ca(OAc)₂ | 4 | Liquid |
| 19 | Mg(OH)₂ | 4 | Liquid |
| 20 | Ca(OAc)₂ | 4 | Liquid |
| 21 | Ca(OAc)₂ | 4 | Flakes |
| 22 | Ca(OAc)₂ | 6.1 | Flakes |
| 23 | Ca(OAc)₂ | 10 | Flakes |
| 24 | Ca(OAc)₂ | 17 | Flakes |
| 25 | Ca(OAc)₂ | 32.2 | Flakes |
| 26 | Ca(OAc)₂ | 2 | Flakes |
| 27 | Ca(OAc)₂ | 4 | Flakes |
| 28 | Ca(OAc)₂ | 8 | Flakes |
| 29 | Ca(OAc)₂ | 15 | Flakes |
| 30 | Ca(OAc)₂ | 30 | Flakes |

### Composition 1—Lab Book 2609/091 (Comparative)

174.8 g foodgrade L-Tartaric Acid was together with 379.2 g acetic acid anhydride dosed into a 1 L three-necked round bottomed flask equipped with overhead stirrer, condenser and thermometer. 2.8 mL 1% H₂SO₄ in acetic acid v/v was added slowly while stirring with an overhead stirrer. The reaction mixture was heated to 110° C. for approx. 10 min.

149.3 g Distilled monoglyceride, DIMODAN® HP KOSHER (from DuPont Nutrition Biosciences ApS, Denmark) and 175.1 g DIMODAN® HR KOSHER (from DuPont Nutrition Biosciences ApS, Denmark) was charged into another three-necked round bottomed flask. 0.168 g Ca(OAc)₂ (to neutralize the H₂SO₄ catalyst in the first reaction) was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar). 113.4 g hardened palm oil (Iodine value <5) (obtained from Cargil) was then added.

Finally acetic acid residues were removed by passing water vapor through the melted product at 110° C. and 10 mbar for 30 min.

By this procedure it was possible to obtain a product containing less than 0.1% free acetic acid.

The product had a degree of neutralization of:

$$x = \frac{( \frac{q \cdot {m}_{{Ca ( AcO )}_{2}}}{M {W}_{{Ca ( AcO )}_{2}}} )}{( \frac{{m}_{tartaricacid}}{{Mw}_{tartaricacid}} )} \cdot 100 \% = \frac{( \frac{2 \cdot 0.168}{158.17} )}{( \frac{174.8}{150.09} )} \cdot 100 \% = 0.18 \%$$

### Composition 2—(Comparative)

174.8 g foodgrade L-Tartaric Acid was together with 379.2 g acetic acid anhydride dosed into a 1 L three-necked round bottomed flask equipped with overhead stirrer, condenser and thermometer. 2.8 mL 1% H₂SO₄ in acetic acid v/v was added slowly while stirring with an overhead stirrer. The reaction mixture was heated to 110° C. for approx. 10 min.

149.3 g Distilled monoglyceride, DIMODAN® HP KOSHER (from DuPont Nutrition Biosciences ApS, Denmark) and 175.1 g DIMODAN® HR KOSHER (from DuPont Nutrition Biosciences ApS, Denmark) was charged into another three-necked round bottomed flask. 0.18 g NaOAc (to neutralize the H₂SO₄ catalyst in the first reaction) was added and mixed thoroughly into the melted monoglyceride.

The tartaric acid, acetic acid anhydride mixture was added to the monoglyceride containing NaOAc. The reaction mixture was heated to approx. 105° C. and acetic acid was distilled off at reduced pressure (115 mbar-15 mbar). 113.4 g hardened palm oil (Iodine value <5) (obtained from Cargil) was then added.

Finally acetic acid residues were removed by passing water vapor through the melted product at 110° C. and 10 mbar for 30 min.

By this procedure it was possible to obtain a product containing less than 0.1% free acetic acid.

The product had a degree of neutralization of:

$$x = \frac{( \frac{q \cdot {m}_{NaOAc}}{M {W}_{NaOAc}} )}{( \frac{{m}_{tartaricacid}}{{Mw}_{tartaricacid}} )} \cdot 100 \% = \frac{( \frac{0.18}{82.03} )}{( \frac{174.8}{150.09} )} \cdot 100 \% = 0.18 \%$$

### Composition 3—(Comparative)

174.8 g foodgrade L-Tartaric Acid was together with 379.2 g acetic acid anhydride dosed into a 1 L three-necked round bottomed flask equipped with overhead stirrer, condenser and thermometer. 2.8 mL 1% H₂SO₄ in acetic acid v/v was added slowly while stirring with an overhead stirrer. The reaction mixture was heated to 110° C. for approx. 10 min.

149.3 g Distilled monoglyceride, DIMODAN® HP KOSHER (from DuPont Nutrition Biosciences ApS, Denmark) and 175.1 g DIMODAN® HR KOSHER (from DuPont Nutrition Biosciences ApS, Denmark) was charged into another three-necked round bottomed flask. 0.47 g Mg(OAc)₂.4H₂O (to neutralize the H₂SO₄ catalyst in the first reaction) was added and mixed thoroughly into the melted monoglyceride.

The tartaric acid, acetic acid anhydride mixture was added to the monoglyceride containing Mg(OAc)₂. The reaction mixture was heated to approx. 105° C. and acetic acid was distilled off at reduced pressure (115 mbar-15 mbar). 113.4 g hardened palm oil (Iodine value <5) (obtained from Cargil) was then added.

Finally acetic acid residues were removed by passing water vapor through the melted product at 110° C. and 10 mbar for 30 min.

By this procedure it was possible to obtain a product containing less than 0.1% free acetic acid.

The product had a degree of neutralization of:

$$x = \frac{( \frac{q \cdot {m}_{{Mg ( AcO )}_{2} •4 {H}_{2} O}}{M {W}_{{Mg ( AcO )}_{2} •4 {H}_{2} O}} )}{( \frac{{m}_{tartaricacid}}{{Mw}_{tartaricacid}} )} \cdot 100 \% = \frac{( \frac{2 \cdot 0 , 47}{214.46} )}{( \frac{174.8}{150.09} )} \cdot 100 \% = 0.18 \%$$

### Composition 4—(Comparative)

174.8 g foodgrade L-Tartaric Acid was together with 379.2 g acetic acid anhydride dosed into a 1 L three-necked round bottomed flask equipped with overhead stirrer, condenser and thermometer. 2.8 mL 1% H₂SO₄ in acetic acid v/v was added slowly while stirring with an overhead stirrer. The reaction mixture was heated to 110° C. for approx. 10 min.

149.3 g Distilled monoglyceride, DIMODAN® HP KOSHER (from DuPont Nutrition Biosciences ApS, Denmark) and 175.1 g DIMODAN® HR KOSHER (from DuPont Nutrition Biosciences ApS, Denmark) was charged into another three-necked round bottomed flask. 0.86 g KOAc (to neutralize the H₂SO₄ catalyst in the first reaction) was added and mixed thoroughly into the melted monoglyceride.

The tartaric acid, acetic acid anhydride mixture was added to the monoglyceride containing KOAc. The reaction mixture was heated to approx. 105° C. and acetic acid was distilled off at reduced pressure (115 mbar-15 mbar). 113.4 g hardened palm oil (Iodine value <5) (obtained from Cargil) was then added.

Finally acetic acid residues were removed by passing water vapor through the melted product at 110° C. and 10 mbar for 30 min.

By this procedure it was possible to obtain a product containing less than 0.1% free acetic acid.

The product had a degree of neutralization of:

$$x = \frac{( \frac{q \cdot {m}_{KOAc}}{M {W}_{KOAc}} )}{( \frac{{m}_{tartaricacid}}{{Mw}_{tartaricacid}} )} \cdot 100 \% = \frac{( \frac{0.86}{98.15} )}{( \frac{174.8}{150.09} )} \cdot 100 \% = 0.18 \%$$

### Composition 5—Lab Book 2609/93

249.5 g foodgrade L-Tartaric Acid was together with 541.2 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min.

462.9 g Distilled monoglyceride, DIMODAN® HR KOSHER (from DuPont Nutrition Biosciences ApS, Denmark) was charged into another three-necked round bottomed flask. 5.21 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar). 162.8 g hardened rapeseed oil (Iodine value <5) (obtained from Cargil) was then added.

Finally acetic acid residues were removed by passing water vapor through the melted product at 110° C. and 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{M {W}_{{Ca ( AcO )}_{2}}} )}{( \frac{{m}_{tartaricacid}}{{Mw}_{tartaricacid}} )} \cdot 100 \% = \frac{( \frac{2 \cdot 5.21}{158.17} )}{( \frac{249.5}{150.09} )} \cdot 100 \% = 3.9 \%$$

### Composition 6—Lab Book 2609/132

150.00 g foodgrade L-Tartaric Acid was together with 321.0 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

334.4 g Distilled monoglyceride, DIMODAN® HR KOSHER (from DuPont Nutrition Biosciences ApS, Denmark) was charged into another three-necked round bottomed flask. 3.32 g NaOAc was added and mixed thoroughly into the melted monoglyceride.

The tartaric acid, acetic acid anhydride mixture was added to the monoglyceride containing NaOAc. The reaction mixture was heated to approx. 110° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{NaOAc}}{M {W}_{NaOAc}} )}{( \frac{{m}_{tartaricacid}}{{Mw}_{tartaricacid}} )} \cdot 100 \% = \frac{( \frac{3.32}{82.03} )}{( \frac{150.00}{150.09} )} \cdot 100 \% = 4.0 \%$$

### Composition 7—Lab Book 2609/134

150.00 g foodgrade L-Tartaric Acid was together with 321.0 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

334.4 g Distilled monoglyceride, DIMODAN® HR KOSHER (from DuPont Nutrition Biosciences ApS, Denmark) was charged into another three-necked round bottomed flask. 3.98 g KOAc was added and mixed thoroughly into the melted monoglyceride.

The tartaric acid, acetic acid anhydride mixture was added to the monoglyceride containing KOAc. The reaction mixture was heated to approx. 110° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{KOAc}}{M {W}_{KOAc}} )}{( \frac{{m}_{tartaricacid}}{{Mw}_{tartaricacid}} )} \cdot 100 \% = \frac{( \frac{3.98}{98.15} )}{( \frac{150.00}{150.09} )} \cdot 100 \% = 4.0 \%$$

### Composition 8—Lab Book 2609/136

150.00 g foodgrade L-Tartaric Acid was together with 321.0 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

334.4 g Distilled monoglyceride, DIMODAN® HR KOSHER (from DuPont Nutrition Biosciences ApS, Denmark) was charged into another three-necked round bottomed flask. 5.08 g Mg(OAc)₂.4H₂O was added and mixed thoroughly into the melted monoglyceride.

The tartaric acid, acetic acid anhydride mixture was added to the monoglyceride containing Mg(OAc)₂.4H₂O. The reaction mixture was heated to approx. 110° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Mg ( AcO )}_{2} •4 {H}_{2} O}}{M {W}_{{Mg ( AcO )}_{2} •4 {H}_{2} O}} )}{( \frac{{m}_{tartaricacid}}{{Mw}_{tartaricacid}} )} \cdot 100 \% = \frac{( \frac{2 \cdot 5.08}{214.46} )}{( \frac{150.00}{150.09} )} \cdot 100 \% = 4.0 \%$$

### Composition 9—Lab Book 20140122-014-01

150.07 g foodgrade L-Tartaric Acid was together with 325.81 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.82 g Distilled monoglyceride, DIMODAN® BP (from DuPont Nutrition Biosciences ApS, Denmark) was charged into another three-necked round bottomed flask. 4.3 g Mg(OAc)₂.4H₂O was added and mixed thoroughly into the melted monoglyceride.

The tartaric acid, acetic acid anhydride mixture was added to the monoglyceride containing Mg(OAc)₂.4H₂O. The reaction mixture was heated to approx. 110° C. and acetic acid was distilled off at reduced pressure (115 mbar-15 mbar). 102.8 g acetic acid anhydride was dosed into the reaction mixture which was heated to 130° C. for 30 minutes. After distilling off acetic acid at reduced pressure (115-15 mbar) at 115° C. thereby 93.7 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Mg ( AcO )}_{2} •4 {H}_{2} O}}{M {W}_{{Mg ( AcO )}_{2} •4 {H}_{2} O}} )}{( \frac{{m}_{tartaricacid}}{{Mw}_{tartaricacid}} )} \cdot 100 \% = \frac{( \frac{2 \cdot 4.30}{214.46} )}{( \frac{150.07}{150.09} )} \cdot 100 \% = 4.0 \%$$

### Composition 10—Lab Book 20140122-014-02

150.11 g foodgrade L-Tartaric Acid was together with 325.89 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

178.47 g Distilled monoglyceride, DIMODAN® BP (from DuPont Nutrition Biosciences ApS, Denmark) was charged into another three-necked round bottomed flask. 1.60 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 110° C. and acetic acid was distilled off at reduced pressure (115 mbar-15 mbar) for approx. 10 min. 178.47 g Distilled monoglyceride, DIMODAN® BP (from DuPont Nutrition Biosciences ApS, Denmark) containing 1.60 g Ca(OAc)₂ was charged into the three-necked round bottomed flask. 103.0 g acetic acid anhydride was dosed into the reaction mixture which was heated to 130° C. for 30 minutes. After distilling off acetic acid at reduced pressure (115-15 mbar) at 115° C. thereby 93.8 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{M {W}_{{Ca ( AcO )}_{2}}} )}{( \frac{{m}_{tartaricacid}}{{Mw}_{tartaricacid}} )} \cdot 100 \% = \frac{( \frac{2 \cdot 3 , 20}{158.17} )}{( \frac{150.11}{150.09} )} \cdot 100 \% = 3.9 \%$$

### Composition 11—Lab Book 20140122-014-03

150.07 g foodgrade L-Tartaric Acid was together with 325.81 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.89 g Distilled monoglyceride, DIMODAN® BP (from DuPont Nutrition Biosciences ApS, Denmark) was charged into another three-necked round bottomed flask. 72.9 g acetic acid anhydride was dosed and the mixture was heated to 150° C. for 30 min. and here after cooled to 80° C. 3.2 g Ca(OAc)₂ was added. Then the tartaric acid, acetic acid anhydride mixture was added. The reaction mixture was heated to approx. 110° C. and acetic acid was distilled off at reduced pressure (115 mbar-15 mbar). 22.5 g acetic acid anhydride was dosed into the reaction mixture which was heated to 130° C. for 30 minutes. After distilling off acetic acid at reduced pressure (115-15 mbar) at 115° C. thereby 93.81 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{M {W}_{{Ca ( AcO )}_{2}}} )}{( \frac{{m}_{tartaricacid}}{{Mw}_{tartaricacid}} )} \cdot 100 \% = \frac{( \frac{2 \cdot 3 , 20}{158.17} )}{( \frac{150.07}{150.09} )} \cdot 100 \% = 3.9 \%$$

### Composition 12—Lab Book 20140122-014-04

150.01 g foodgrade L-Tartaric Acid was together with 325.89 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.84 g Distilled monoglyceride, C (from DuPont Nutrition Biosciences ApS, Denmark) was charged into another three-necked round bottomed flask. 72.7 g acetic acid anhydride was dosed and the mixture was heated to 150° C. for 30 min. and here after cooled to 80° C. 3.2 g Ca(OAc)₂ was added. The mixture was divide into two equally large portions and the tartaric acid, acetic acid anhydride mixture was added to one of them. The reaction mixture was heated to approx. 110° C. and acetic acid was distilled off at reduced pressure (115 mbar-15 mbar) for approx. 10 min. The second half of the reaction mixture (DIMODAN® BP (from DuPont Nutrition Biosciences ApS, Denmark) and acetic acid anhydride, containing Ca(OAc)₂) was charged into the three-necked round bottomed flask. 22.53 g acetic acid anhydride was dosed into the reaction mixture which was heated to 130° C. for approx. 30 minutes. After distilling off acetic acid at reduced pressure (115-15 mbar) at 115° C. thereby 93.69 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{M {W}_{{Ca ( AcO )}_{2}}} )}{( \frac{{m}_{tartaricacid}}{{Mw}_{tartaricacid}} )} \cdot 100 \% = \frac{( \frac{2 \cdot 3 , 20}{158.17} )}{( \frac{150.11}{150.09} )} \cdot 100 \% = 3.9 \%$$

### Composition 13—Lab Book 20140225-008-1

150.03 g foodgrade L-Tartaric Acid was together with 325.89 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.91 g Distilled monoglyceride, DIMODAN® BP (from DuPont Nutrition Biosciences ApS, Denmark) was charged into another three-necked round bottomed flask. 4.3 g Magnesium lactate was added and mixed thoroughly into the melted monoglyceride.

The tartaric acid, acetic acid anhydride mixture was added to the monoglyceride containing Magnesium lactate. The reaction mixture was heated to approx. 110° C. and acetic acid was distilled off at reduced pressure (115 mbar-15 mbar). 102.9 g acetic acid anhydride was dosed into the reaction mixture which was heated to 130° C. for 30 minutes. After distilling off acetic acid at reduced pressure (115-15 mbar) at 115° C. thereby 93.8 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{Magnesiumlactate}}{M {W}_{Magnesiumlactate}} )}{( \frac{{m}_{tartaricacid}}{{Mw}_{tartaricacid}} )} \cdot 100 \% = \frac{( \frac{2 \cdot 4.30}{202.45} )}{( \frac{150.03}{150.09} )} \cdot 100 \% = 4.0 \%$$

### Composition 14—Lab Book 20140225-008-2

150.05 g foodgrade L-Tartaric Acid was together with 331.01 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.18 g Distilled monoglyceride, DIMODAN® BP (from DuPont Nutrition Biosciences ApS, Denmark) was charged into another three-necked round bottomed flask. 3.2 g NaOAc was added and mixed thoroughly into the melted monoglyceride.

The tartaric acid, acetic acid anhydride mixture was added to the monoglyceride containing NaOAc. The reaction mixture was heated to approx. 110° C. and acetic acid was distilled off at reduced pressure (115 mbar-15 mbar). 102.82 g acetic acid anhydride was dosed into the reaction mixture which was heated to 130° C. for 30 minutes. After distilling off acetic acid at reduced pressure (115-15 mbar) at 115° C. thereby 93.9 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{NaOAc}}{M {W}_{NaOAc}} )}{( \frac{{m}_{tartaricacid}}{{Mw}_{tartaricacid}} )} \cdot 100 \% = \frac{( \frac{3.20}{82.03} )}{( \frac{150.05}{150.09} )} \cdot 100 \% = 3.9 \%$$

### Composition 15—Lab Book 20140225-008-3

150.05 g foodgrade L-Tartaric Acid was together with 331.01 g acetic acid anhydride dosed into a 1 L three-necked round bottomed flask equipped with overhead stirrer, condenser and thermometer. 1 mL 1% H₂SO₄ in acetic acid v/v was added slowly while stirring with an overhead stirrer. The reaction mixture was heated to 110° C. for approx. 10 min.

356.18 g Distilled monoglyceride, DIMODAN® BP (from DuPont Nutrition Biosciences ApS, Denmark) was charged into another three-necked round bottomed flask. 3.9 g KOAc was added and mixed thoroughly into the melted monoglyceride.

The tartaric acid, acetic acid anhydride mixture was added to the monoglyceride containing KOAc. The reaction mixture was heated to approx. 110° C. and acetic acid was distilled off at reduced pressure (115 mbar-15 mbar). 102.82 g acetic acid anhydride was dosed into the reaction mixture which was heated to 130° C. for 30 minutes. After distilling off acetic acid at reduced pressure (115-15 mbar) at 115° C. thereby 93.9 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{KOAc}}{M {W}_{KOAc}} )}{( \frac{{m}_{tartaricacid}}{{Mw}_{tartaricacid}} )} \cdot 100 \% = \frac{( \frac{3.90}{98.15} )}{( \frac{150.05}{150.09} )} \cdot 100 \% = 3 , 9 \%$$

### Composition 16—Lab Book 20140310-016-01

150.04 g foodgrade L-Tartaric Acid was together with 325.87 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min.

356.82 g Distilled monoglyceride, DIMODAN® BP (from DuPont Nutrition Biosciences ApS, Denmark) was charged into another three-necked round bottomed flask. 3.20 g Ca(OAc)₂ was added and mixed thoroughly into the melted monoglyceride.

The monoglyceride containing Ca(OAc)₂ was added to the tartaric acid, acetic acid anhydride mixture. The reaction mixture was heated to approx. 105° C. and acetic acid was distilled off at reduced pressure (115 mbar-15 mbar). 102.84 g acetic acid anhydride was dosed into the reaction mixture which was heated to 130° C. for 30 minutes. After distilling off acetic acid at reduced pressure (115-15 mbar) at 115° C. thereby 93.9 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 3.2}{214.46} )}{( \frac{150.04}{150.09} )} \cdot 100 \% = 3.9 \%$$

### Composition 17—Lab Book 20140310-016-02

150.04 g foodgrade L-Tartaric Acid was together with 325.87 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min. The pressure was gradually reduced to distill off acetic acid for approximately 10 min.

356.82 g Distilled monoglyceride, DIMODAN® BP (from DuPont Nutrition Biosciences ApS, Denmark) was charged into another three-necked round bottomed flask. 3.20 g Ca(OAc)₂ was added and mixed thoroughly into the melted monoglyceride.

The tartaric acid, acetic acid anhydride mixture was added to The monoglyceride containing Ca(OAc)₂. The reaction mixture was heated to approx. 105° C. and acetic acid was distilled off at reduced pressure (115 mbar-15 mbar). 102.84 g acetic acid anhydride was dosed into the reaction mixture which was heated to 130° C. for 30 minutes. After distilling off acetic acid at reduced pressure (115-15 mbar) at 115° C. thereby 93.9 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 3.2}{214.46} )}{( \frac{150.04}{150.09} )} \cdot 100 \% = 3.9 \%$$

### Composition 18—Lab Book 20140310-016-04

150.04 g foodgrade L-Tartaric Acid was together with 325.87 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min. 356.82 g Distilled monoglyceride, DIMODAN® BP (from DuPont Nutrition Biosciences ApS, Denmark) was charged into another three-necked round bottomed flask.

The tartaric acid, acetic acid anhydride mixture was added to the monoglyceride. 3.20 g Ca(OAc)₂ was added and mixed thoroughly into the reaction mixture. The reaction mixture was heated to approx. 105° C. and acetic acid was distilled off at reduced pressure (115 mbar-15 mbar). 102.84 g acetic acid anhydride was dosed into the reaction mixture which was heated to 130° C. for 30 minutes. After distilling off acetic acid at reduced pressure (115-15 mbar) at 115° C. thereby 93.9 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 3.2}{214.46} )}{( \frac{150.04}{150.09} )} \cdot 100 \% = 3.9 \%$$

### Composition 19—Lab Book 20140403-001-02

150.02 g foodgrade L-Tartaric Acid was together with 325.81 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min. 356.84 g Distilled monoglyceride, DIMODAN® BP (from DuPont Nutrition Biosciences ApS, Denmark) was charged into another three-necked round bottomed flask.

The tartaric acid, acetic acid anhydride mixture was added to the monoglyceride. 1.20 g Mg(OH)₂ was added and mixed thoroughly into the reaction mixture. The reaction mixture was heated to approx. 105° C. and acetic acid was distilled off at reduced pressure (115 mbar-15 mbar). 102.82 g acetic acid anhydride was dosed into the reaction mixture which was heated to 130° C. for 30 minutes. After distilling off acetic acid at reduced pressure (115-15 mbar) at 115° C. thereby 93.7 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Mg ( OH )}_{2}}}{{MW}_{{Mg ( OH )}_{2}}} )}{( \frac{{m}_{tartaricacid}}{{Mw}_{tartaricacid}} )} \cdot 100 \% = \frac{( \frac{2 \cdot 1.2}{58.32} )}{( \frac{150.02}{150.09} )} \cdot 100 \% = 4.0 \%$$

### Composition 20—Lab Book 2609/122

150.0 g foodgrade L-Tartaric Acid was together with 325.8 g acetic acid anhydride dosed into a 1 L three-necked round bottomed flask equipped with overhead stirrer, condenser and thermometer. 2 mL 1% H₂SO₄ in acetic acid v/v was added slowly while stirring with an overhead stirrer. The reaction mixture was heated to 110° C. for approx. 10 min.

356.8 g Distilled monoglyceride, DIMODAN® BP (from DuPont Nutrition Biosciences ApS, Denmark) was charged into another three-necked round bottomed flask. 3.2 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar). 102.8 g acetic acid anhydride was dosed into the reaction mixture which was heated to 130° C. for 30 minutes. After distilling off acetic acid at reduced pressure (115-15 mbar) at 115° C. thereby 93.7 g sunflower oil (obtained from Cargill) was added.

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 3.20}{158.17} )}{( \frac{150.00}{150.09} )} \cdot 100 \% = 4.0 \%$$

### Composition 21—Lab Book 2697/186

99.0 g foodgrade L-Tartaric Acid was together with 212.6 g acetic acid anhydride dosed into a 1 L three-necked round bottomed flask equipped with overhead stirrer, condenser and thermometer. 0.67 mL 1% H₂SO₄ in acetic acid v/v was added slowly while stirring with an overhead stirrer. The reaction mixture was heated to 110° C. for approx. 10 min.

133.2 g Distilled monoglyceride, DIMODAN® HR KOSHER and 217.0 g Mono-Diglyderide HP (from DuPont Nutrition Biosciences ApS, Denmark) was charged into another three-necked round bottomed flask. 2.13 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 2.13}{158.17} )}{( \frac{99.00}{150.09} )} \cdot 100 \% = 4.0 \%$$

### Composition 22—Lab Book 2697/187

99.0 g foodgrade L-Tartaric Acid was together with 215.6 g acetic acid anhydride dosed into a 1 L three-necked round bottomed flask equipped with overhead stirrer, condenser and thermometer. 0.67 mL 1% H₂SO₄ in acetic acid v/v was added slowly while stirring with an overhead stirrer. The reaction mixture was heated to 110° C. for approx. 10 min.

133.0 g Distilled monoglyceride, DIMODAN® HR KOSHER and 217.1 g Mono-Diglyderide HP (from DuPont Nutrition Biosciences ApS, Denmark) was charged into another three-necked round bottomed flask. 3.2 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 3.2}{158.17} )}{( \frac{99.00}{150.09} )} \cdot 100 \% = 6.1 \%$$

### Composition 23—Lab Book 2697/188

99.1 g foodgrade L-Tartaric Acid was together with 212.5 g acetic acid anhydride dosed into a 1 L three-necked round bottomed flask equipped with overhead stirrer, condenser and thermometer. 0.67 mL 1% H₂SO₄ in acetic acid v/v was added slowly while stirring with an overhead stirrer. The reaction mixture was heated to 110° C. for approx. 10 min.

133.0 g Distilled monoglyceride, DIMODAN® HR KOSHER and 217.4 g Mono-Diglyderide HP (from DuPont Nutrition Biosciences ApS, Denmark) was charged into another three-necked round bottomed flask. 5.2 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 5.2}{158.17} )}{( \frac{99.1}{150.09} )} \cdot 100 \% = 10.0 \%$$

### Composition 24—Lab Book 2697/189

99.4 g foodgrade L-Tartaric Acid was together with 213.6 g acetic acid anhydride dosed into a 1 L three-necked round bottomed flask equipped with overhead stirrer, condenser and thermometer. 0.67 mL 1% H₂SO₄ in acetic acid v/v was added slowly while stirring with an overhead stirrer. The reaction mixture was heated to 110° C. for approx. 10 min.

133.1 g Distilled monoglyceride, DIMODAN® HR KOSHER and 216.8 g Mono-Diglyderide HP (from DuPont Nutrition Biosciences ApS, Denmark) was charged into another three-necked round bottomed flask. 8.9 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 8.9}{158.17} )}{( \frac{99.4}{150.09} )} \cdot 100 \% = 17.0 \%$$

### Composition 24—Lab Book 2697/190

99.1 g foodgrade L-Tartaric Acid was together with 212.3 g acetic acid anhydride dosed into a 1 L three-necked round bottomed flask equipped with overhead stirrer, condenser and thermometer. 0.67 mL 1% H₂SO₄ in acetic acid v/v was added slowly while stirring with an overhead stirrer. The reaction mixture was heated to 110° C. for approx. 10 min.

132.0 g Distilled monoglyceride, DIMODAN® HR KOSHER and 215.1 g Mono-Diglyderide HP (from DuPont Nutrition Biosciences ApS, Denmark) was charged into another three-necked round bottomed flask. 16.7 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 16.8}{158.17} )}{( \frac{99.1}{150.09} )} \cdot 100 \% = 32.2 \%$$

### Composition 25—Lab Book 2697/191

134.6 g foodgrade L-Tartaric Acid was together with 288.56 g acetic acid anhydride dosed into a 1 L three-necked round bottomed flask equipped with overhead stirrer, condenser and thermometer. 0.90 mL 1% H₂SO₄ in acetic acid v/v was added slowly while stirring with an overhead stirrer. The reaction mixture was heated to 110° C. for approx. 10 min.

114.6 g Distilled monoglyceride, DIMODAN® HR KOSHER and 185.6 g Mono-Diglyderide HP (from DuPont Nutrition Biosciences ApS, Denmark) was charged into another three-necked round bottomed flask. 1.4 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 1.4}{158.17} )}{( \frac{134.6}{150.09} )} \cdot 100 \% = 2.0 \%$$

### Composition 26—Lab Book 2697/192

134.4 g foodgrade L-Tartaric Acid was together with 288.0 g acetic acid anhydride dosed into a 1 L three-necked round bottomed flask equipped with overhead stirrer, condenser and thermometer. 0.90 mL 1% H₂SO₄ in acetic acid v/v was added slowly while stirring with an overhead stirrer. The reaction mixture was heated to 110° C. for approx. 10 min.

114.0 g Distilled monoglyceride, DIMODAN® HR KOSHER and 185.4 g Mono-Diglyderide HP (from DuPont Nutrition Biosciences ApS, Denmark) was charged into another three-necked round bottomed flask. 2.8 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 2.8}{158.17} )}{( \frac{134.4}{150.09} )} \cdot 100 \% = 4.0 \%$$

### Composition 27—Lab Book 2697/193

134.8 g foodgrade L-Tartaric Acid was together with 287.3 g acetic acid anhydride dosed into a 1 L three-necked round bottomed flask equipped with overhead stirrer, condenser and thermometer. 0.90 mL 1% H₂SO₄ in acetic acid v/v was added slowly while stirring with an overhead stirrer. The reaction mixture was heated to 110° C. for approx. 10 min.

113.6 g Distilled monoglyceride, DIMODAN® HR KOSHER and 185.1 g Mono-Diglyderide HP (from DuPont Nutrition Biosciences ApS, Denmark) was charged into another three-necked round bottomed flask. 5.7 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 5.7}{158.17} )}{( \frac{134.8}{150.09} )} \cdot 100 \% = 8.0 \%$$

### Composition 27—Lab Book 2697/194

134.5 g foodgrade L-Tartaric Acid was together with 288.5 g acetic acid anhydride dosed into a 1 L three-necked round bottomed flask equipped with overhead stirrer, condenser and thermometer. 0.90 mL 1% H₂SO₄ in acetic acid v/v was added slowly while stirring with an overhead stirrer. The reaction mixture was heated to 110° C. for approx. 10 min.

113.2 g Distilled monoglyceride, DIMODAN® HR KOSHER and 184.3 g Mono-Diglyderide HP (from DuPont Nutrition Biosciences ApS, Denmark) was charged into another three-necked round bottomed flask. 10.6 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 10.6}{158.17} )}{( \frac{134.5}{150.09} )} \cdot 100 \% = 15.0 \%$$

### Composition 28—Lab Book 2697/195

134.5 g foodgrade L-Tartaric Acid was together with 287.9 g acetic acid anhydride dosed into a 1 L three-necked round bottomed flask equipped with overhead stirrer, condenser and thermometer. 0.90 mL 1% H₂SO₄ in acetic acid v/v was added slowly while stirring with an overhead stirrer. The reaction mixture was heated to 110° C. for approx. 10 min.

112.5 g Distilled monoglyceride, DIMODAN® HR KOSHER and 182.6 g Mono-Diglyderide HP (from DuPont Nutrition Biosciences ApS, Denmark) was charged into another three-necked round bottomed flask. 10.6 g Ca(OAc)₂ was added and mixed thoroughly into the melted monoglyceride.

The tartaric acid, acetic acid anhydride mixture was added to the monoglyceride containing Ca(OAc)₂. The reaction mixture was heated to approx. 105° C. and acetic acid was distilled off at reduced pressure (115 mbar-15 mbar).

Finally acetic acid residues were removed by passing water vapor through the melted product at 110° C. and approx. 10 mbar for 30 min.

By this procedure it was possible to obtain a product containing less than 0.1% free acetic acid.

The degree of neutralization was:

$$x = \frac{( \frac{q \cdot {m}_{{Ca ( AcO )}_{2}}}{{MW}_{{Ca ( AcO )}_{2}}} )}{( \frac{{m}_{tartaricacid}}{{Mw}_{tartaricacid}} )} \cdot 100 \% = \frac{( \frac{2 \cdot 21.3}{158.17} )}{( \frac{134.5}{150.09} )} \cdot 100 \% = 30.0 \%$$

### Headspace Analysis

The samples were tested for odor/acetic acid content by headspace analysis. The details of the process are as follows.

Transfer 100 mg of sample to a 22 ml vial and equilibrate for 5 minutes at 30° C. Subsequently, the volatiles were extracted from the gas phase for 20 minutes at 30° C. using the Solid Phase MicroExtraction principle (SPME). Then the volatiles are thermodesorbed at 260° C. in the injection port of a GC/MS system, and a chromatogram was acquired. Acetic acid response (area under the peak for acetic acid in the chromatogram compared to the response at t=0) was plotted vs time.

### Results

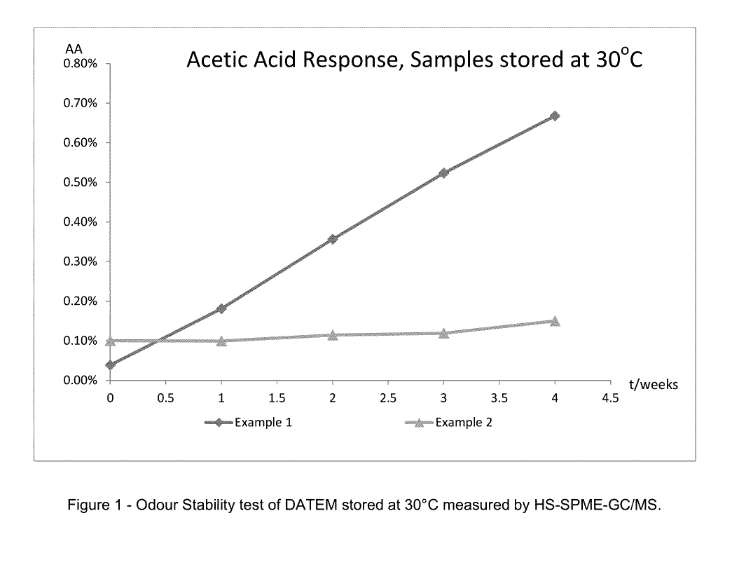

The headspace analysis of sample 1 and sample 5 over time was plotted. The results are shown in FIG. 1.

It can be clearly seen that the stabilization of example 5 with the high level of calcium salt present is significant over example 1 with low level of calcium salt. Over a period of approximately 4 weeks the non-stabilized sample increased in acetic acid level such that it became unacceptable for use in some food applications because of the odour resulting from acetic acid.

The results of the final headspace analysis of multiple further compositions, including after storage of periods of up to approximately 1 year, are provided in Table 1 below.

TABLE 1

| Composition | | Acetic Acid content |
|---|---|---|
| # | Days Before Testing | (%) |
| 1 (Comparative) | 28 | 0.67 |
| 6 | 325 | 0.03 |
| 7 | 324 | 0.16 |
| 8 | 322 | 0.02 |
| 9 | 93 | 0.04 |
| 13 | 58 | 0.13 |
| 14 | 58 | 0.4 |
| 15 | 58 | 0.23 |
| 19 | 58 | 0.03 |
| 20 | 339 | 0.1 |

Compared with non-stabilised DATEM the inventive product has a significant lower odour and significant improved stability at ambient temperature, which increases the storage stability of the DATEM product itself; increases the practical manageability of the DATEM product in food applications for improved working environment, food quality, and shelf life.

All publications mentioned in the above specification are herein incorporated by reference. Various modifications and variations of the described methods and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry or related fields are intended to be within the scope of the following claims.

1. An emulsifier composition, wherein the emulsifier composition comprises:
(a) a diacetyl tartaric acid ester of mono- and diglycerides (DATEM);
(b) free acetic acid in an amount of less than 0.4 wt % based on the amount of DATEM; and
(c) a salt or base, wherein:
i) the salt or base is capable of donating a metal ion to one or more carboxylic acids present in the DATEM to form a salt of the carboxylic acid present in the DATEM, and
ii) the salt or base is present in an amount to provide a degree of neutralisation of at least 0.25 mol %.

2. An emulsifier composition according to claim 1 wherein free acetic acid is present in an amount of less than 0.1 wt % based on the amount of DATEM.

3. An emulsifier composition according to claim 1 wherein:
the salt or base (c) is capable of donating a metal ion to one or more carboxylic acids selected from DATEM I, DATEM II, DATEM III, DATEM IV, positional isomers thereof, free acetic acid and mixtures thereof to form a salt of the one or more carboxylic acids;
DATEMI corresponds in structure to: 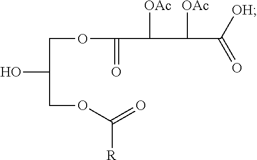
DATEMII corresponds in structure to: 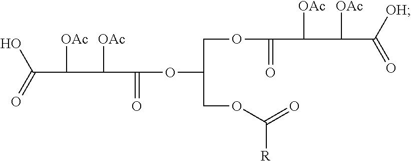
DATEMIII corresponds in structure to: 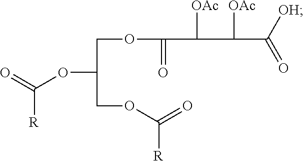
DATEMIV corresponds in structure to: 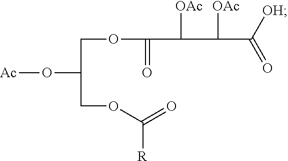
and
R is a fatty acid chain.

4. An emulsifier composition according to claim 1 wherein:
the salt or base (c) is a salt, and
the salt is a metal salt capable of donating a metal ion to one or more carboxylic acids present in the DATEM to form a salt of the carboxylic acid present in the DATEM.

5. An emulsifier composition according to claim 1 wherein the salt or base (c) is a salt or base of a metal selected from Group 1 of the periodic table, Group 2 of the periodic table and aluminum.

6. An emulsifier composition according to claim 1 wherein the salt or base (c) is a salt or base of a metal selected from lithium, sodium, potassium, magnesium, calcium and aluminium.

7. An emulsifier composition according to claim 1 wherein:
the salt or base (c) is a salt, and
the salt is a salt of calcium.

8. An emulsifier composition according to claim 1 wherein:
the salt or base (c) is a salt; and
the salt is a salt of an acid selected from formic acid, acetic acid, propionic acid and lactic acid.

9. An emulsifier composition according to claim 1 wherein the salt or base (c) is selected from magnesium hydroxide, calcium acetate, sodium acetate, magnesium acetate, magnesium lactate, potassium acetate and aluminium acetate and mixtures thereof.

10. An emulsifier composition according to claim 1 wherein:
the salt or base (c) is a salt, and
the salt is calcium acetate.

11. An emulsifier composition according to claim 1 wherein the salt or base (c) is present in an amount of at least 0.1 wt % based on the amount of DATEM.

12. An emulsifier composition according to claim 1 wherein:
the salt or base (c) is a salt, and
the salt is present in an amount of from 0.1 to 1.0 wt % based on the amount of DATEM.

13. An emulsifier composition according to claim 1 wherein the salt or base is present in an amount to provide a degree of neutralisation of at least 2 mol %.

14. An emulsifier composition according to claim 1 wherein the DATEM comprises tartaric acid in an amount of 10 to 30 wt %.

15. An emulsifier composition according to claim 1 wherein, during storage at 30° C. for 28 days, the amount of free acetic acid present in the composition increases by less than 100%.

16. A process for the preparation of an emulsifier composition, wherein:
the emulsifier composition comprises:
(a) a diacetyl tartaric acid ester of mono- and diglycerides (DATEM);
(b) free acetic acid in an amount of less than 0.4 wt % based on the amount of DATEM; and
(c) a salt or base, wherein:
1) the salt or base is capable of donating a metal ion to one or more carboxylic acids present in the DATEM to form a salt of the carboxylic acid present in the DATEM, and
2) the salt or base is present in an amount to provide a degree of neutralisation of at least 0.25 mol %;
the process comprises
i) providing a diacetyl tartaric acid ester of mono- and diglycerides (DATEM);
ii) optionally deodorising the DATEM such that the DATEM contains free acetic acid in an amount of less than 0.4 wt % based on the amount of DATEM; and
iii) combining the DATEM with a salt or base;
the salt or base is capable of donating a metal ion to one or more carboxylic acids present in the DATEM to form a salt of the carboxylic acid present in the DATEM; and
if step ii) is performed, step iii) may be performed either before or after step ii).

17. A process according to claim 16 wherein step ii) is performed and the DATEM is deodorised to contain free acetic acid in an amount of less than 0.4 wt % based on the amount of DATEM.

18. A process according to claim 16 wherein:
step ii) is performed, and
the DATEM is combined with the salt or base prior to step ii).

19. A process according to claim 16, wherein the emulsifier composition comprises less than 0.1 wt % free acetic acid based on the amount of DATEM.

20. An emulsifier composition obtained or obtainable by the process of claim 16.

21. A food product comprising an emulsifier composition as defined in claim 1.

22. A food product according to claim 21 wherein the food product is a bakery product.

23. A method of stabilising a diacetyl tartaric acid ester of mono- and diglycerides (DATEM), wherein:
the method comprises combining the DATEM with a salt or base, and
the salt or base is capable of donating a metal ion to one or more carboxylic acids present in the DATEM to form a salt of the carboxylic acid present in the DATEM.

24. A method of reducing or inhibiting the release of acetic acid from a diacetyl tartaric acid ester of mono- and diglycerides (DATEM), wherein:
the method comprises combining the DATEM with a salt or base, and
the salt or base is capable of donating a metal ion to one or more carboxylic acids present in the DATEM to form a salt of the carboxylic acid present in the DATEM.

25. A method according to claim 23 wherein the salt or base is present in an amount to provide a degree of neutralisation of at least 0.25 mol %.
